(19) United States
(12) Patent Application Publication
(10) Pub. No.: US 2012/0055664 A1
(43) Pub. Date: Mar. 8, 2012

(54) Cryogenic System for Cooling a Consumer Having a Time-Variable Heat Load

(75) Inventors: Guy Bornard, Biviers (FR); Patrick Bonnay, Voiron (FR); Fanny Clavel, Vif (FR)

(73) Assignee: Commissariat A L'Energie Atomique Et Aux Energies Alternatives, Paris (FR)

(21) Appl. No.: 13/258,686

(22) PCT Filed: Mar. 22, 2010
(86) PCT No.: PCT/FR10/00236

§ 371 Date: Nov. 21, 2011

(30) Foreign Application Priority Data
Mar. 24, 2009 (FR) 0901374

(51) Int. Cl. G05D 16/00

(52) U.S. Cl. 165/281

(57) ABSTRACT

The invention relates to a cryogenic system for cooling a consumer having a time-variable heat load, such as a superconducting magnet, including: a cold box in thermal contact with the consumer, supplied with heat transfer gas compressed by a feed line, and connected to a delivery line for discharging said gas at a lower pressure; and an assembly for adjusting the pressures in the feed and delivery lines, comprising a plurality of controlled valves (CV₁, CV₂, CV₃) and a controller (MC) for controlling the opening of said valves. The invention is characterized in that the controller is a multivariable controller for generating signals (SC^{s}₁, SC^{s}₂, SC^{s}₃) for controlling the opening of said valves according to measured values (P_{HP}, P_{BP}) and set values (P⁰_{HP}, P⁰_{BP}) for the pressures in the feed and delivery lines on the basis of a mathematical model of the system that factors in a coupling between the pressure values in the feed and delivery lines by means of the above-mentioned cold box.

The invention relates to a cryogenic system for cooling a consumer that presents a time-varying thermal load; the invention applies in particular to cooling superconductive magnets.

A cryogenic system for cooling a consumer generally includes a fluid flow circuit in which the heat-conveying gas (N₂ or He) flows under pressure from a compression stage to a “cold box” where it is cooled and partially liquefied by expansion. The cold box contains a bath of liquefied gas in thermal contact with the consumer for cooling. The heat transferred from the consumer to the bath (“thermal load”) causes some of the gas to evaporate, which gas is exhausted from the cold box to the compression stage so as to loop the circuit. By way of example, such a system is described in the article by J. C. Boissin et al. “Cryogenie: mise en ouevre des basses temperatures” [Cryogenics: implementing low temperatures], published by Technique de l'ingénieur, traité Génie énergétique, B 2 382, see in particular section 1.3.7 and FIG. 20.

A system of that type is particularly suitable for cooling a consumer that presents a thermal load that is constant or that varies slowly, but it is found to be relatively ineffective when the thermal load varies significantly over a time scale of the order of minutes or even seconds. Such conditions are to be found in particular when cooling superconductive magnets, and in particular magnets used in tokamaks for research on controlled nuclear fusion.

The conventional way of managing the cooling of consumers presenting thermal loads that vary, e.g. that are pulsed, consists in overdimensioning the cryogenic system without significantly changing its design. Such a solution is not satisfactory from an economic point of view.

Document FR 2 919 713 describes a cryogenic method and installation particularly suitable for cooling consumers that present a thermal load that varies over time. The solution proposed in that document consists in providing a liquefied gas accumulator in the cold section of the installation. The accumulator enables cold fluid to be stored while the value of the thermal load is low, and enables the consumer to be cooled when the thermal load increases.

The accumulator thus behaves like a filter that decouples the variability of the thermal load from the cryogenic circuit, so the cryogenic circuit can continue to operate at a constant rate and may be dimensioned on the basis of the mean thermal load of the consumer, and not on the basis of its peak load.

The drawback of that solution is that it involves a significant increase in the volume and the complexity of the cold region of the installation, and that has unfavorable repercussions on its size and its cost.

The invention seeks to provide a cryogenic system for cooling a consumer that presents a thermal load that varies over time, while avoiding the above-mentioned drawbacks of the prior art.

The idea on which the invention is based consists in modifying the system so as to enable the cryogenic circuit to operate under dynamic conditions, as contrasted to bypassing the problem by “filtering” the variability of the thermal load by means of a cold fluid accumulator.

Furthermore, the inventors have observed that a cryogenic system of conventional type can operate in satisfactory manner under dynamic conditions providing it is provided with appropriate regulator means. In other words, the inventors have understood that adapting a conventional cryogenic system to a variable load can be achieved by techniques that apply to automatic control, without there being any need to modify the hardware structure of the installation significantly, and in particular the structure of its cold portion. It is thus possible both to adapt an existing installation at limited cost, and to simplify greatly the design of installations that are specially dedicated to consumers presenting a variable thermal load.

The invention thus provides a cryogenic system for cooling a consumer presenting a thermal load that varies over time, the system comprising: a cold box in thermal contact with said consumer, fed with a compressed heat-conveying gas by a delivery pipe and connected to a return pipe for exhausting said gas at a lower pressure; and a unit for regulating the pressures in said delivery and return pipes, the unit comprising a plurality of controlled valves and a control device for controlling the opening of said valves; the system being characterized in that said control device is a multivariable regulator adapted to generate opening control signals for said valves as a function of measured values and of setpoint values for the pressures of said delivery and return pipes on the basis of a mathematical model of the system, which model takes account of coupling between the pressure values in the delivery and return pipes via said cold box.

In particular embodiments of the invention:

Said control device may comprise: a first regulator for generating a first signal for controlling said valves on the basis of a first partial model of the system; a second regulator for generating a second signal for controlling said valves on the basis of a second partial model of the system that is different from said first partial model; and a control selector for selectively applying the first or the second control signal to said valves.

Said regulation unit may comprise: a supply of heat-conveying gas at a pressure that is intermediate between the pressure of said delivery pipe and that of said return pipe; a first controlled valve arranged between said supply and said return pipe in order to enable gas to be injected into the return pipe from said supply; a second controlled valve arranged between said supply and said delivery pipe in order to enable gas to be exhausted from the delivery pipe to said supply; and a third controlled valve arranged between said delivery pipe and said return pipe in order to enable the cold box to be bypassed.

Said first regulator may be adapted to generate a first control signal for opening the first and third valves, to the exclusion of said second valve, on the basis of said first partial model of the system; and said second regulator is adapted to generate a second control signal for opening the second and third valves, to the exclusion of said first valve, on the basis of said second partial model of the system.

Said first partial model may model the behavior of the system when a volume of gas is injected into the return pipe, and said second partial model may model the behavior of the system when a volume of gas is extracted from the delivery pipe.

Said mathematical model of the system may model the disturbances in the flow rate of the heat-conveying gas that are induced by variations over time in the heat load of a consumer in thermal communication with said cold box, by means of virtual variations in the openings of the valves of the regulation system, said virtual openings being supplied to said control device as input variables together with the measured and setpoint values for the pressures.

Said control device may be adapted to minimize a cost function that depends on the differences between the pressures measured in the delivery and return pipes and the respective setpoint values therefor, and also on the amplitudes of the control signals generated. In particular, it may be a linear quadratic regulator.

The cold box may contain a supply of liquefied heat-conveying gas that evaporates in part under the effect of the thermal load of a consumer, the evaporated gas being exhausted via the return pipe and replaced by liquefying at least some of the gas coming from said delivery pipe, the variability over time in the gas evaporation and liquefaction rates thereby giving rise to disturbances in the pressures within the delivery and return pipes.

The consumer may be a superconductive magnet that presents a pulsed thermal load.

Other characteristics, details, and advantages of the invention appear on reading the following description made with reference to the accompanying drawings given by way of example, and in which:

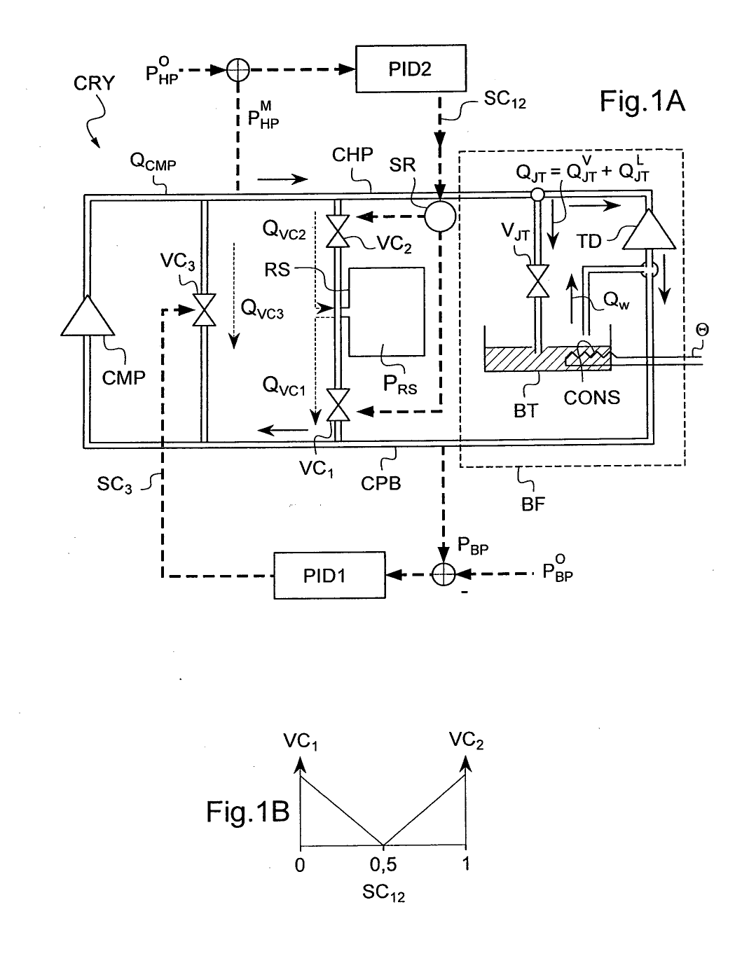

FIG. 1A is a diagram of a cryogenic system of the prior art;

FIG. 1B shows the “split range” principle implemented in the FIG. 1A system;

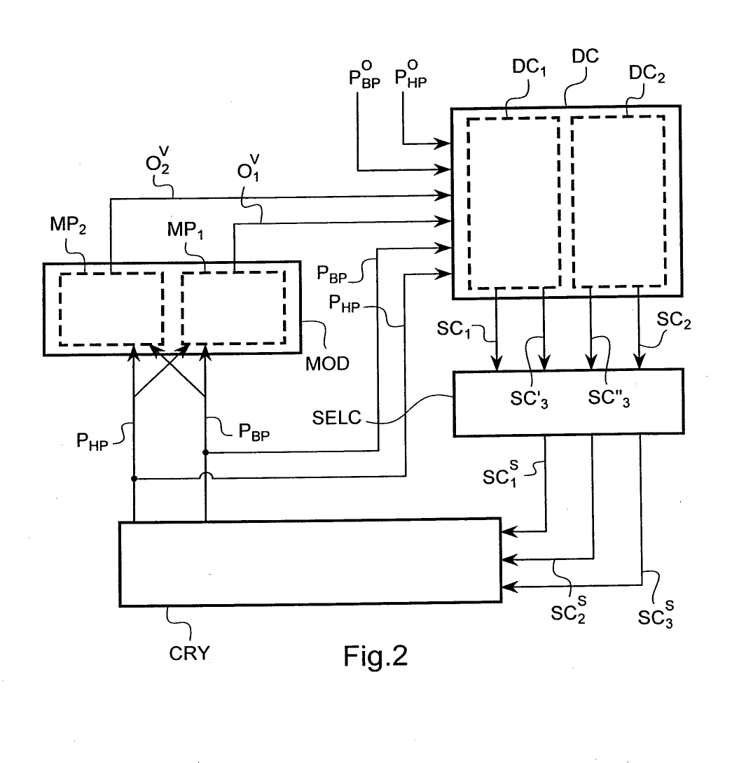

FIG. 2 is a diagram showing the principle of means for regulating a cryogenic system in an embodiment of the invention; and

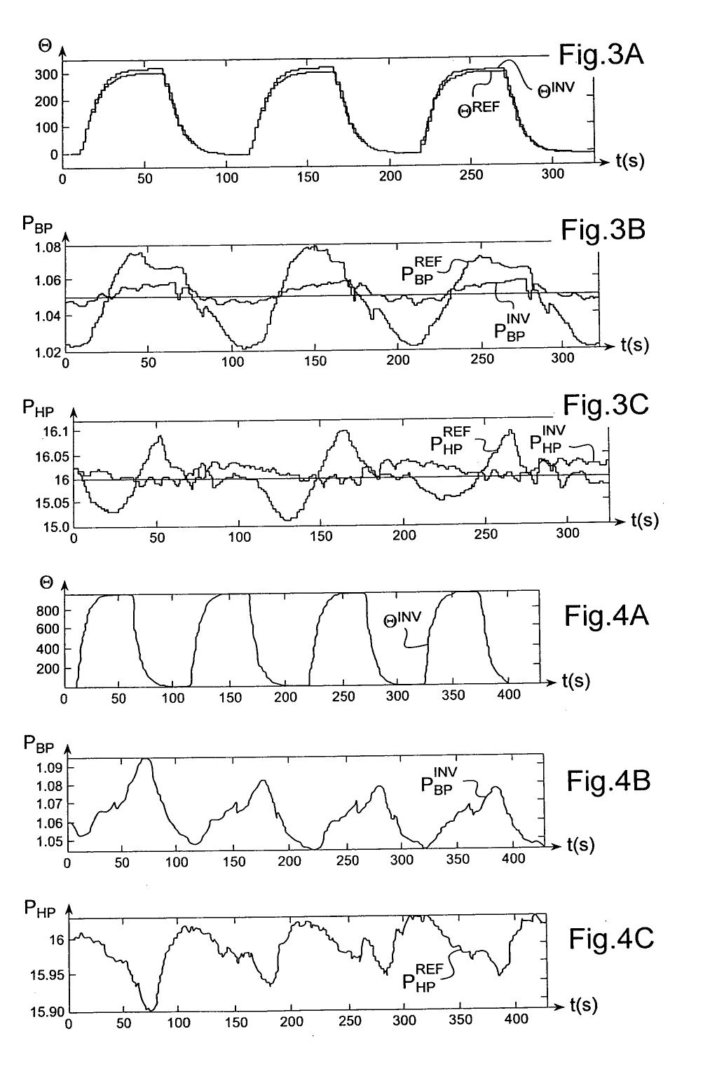

FIGS. 3A, 3B, & 3C, and 4A, 4B, & 4C are graphs showing the behavior of a cryogenic system of the invention under a pulsed thermal load, and how it compares with the prior at.

In simplified manner, FIG. 1A shows the structure and the operation of a helium refrigerator-liquefier CRY of conventional type.

Such an installation comprises a cryogenic circuit having a high pressure pipe CHP, a low pressure pipe CBP, a compression stage CMP, and a cold box BF.

The compression stage CMP may include one or more compressors, e.g. of the screw type, together with a de-oiler (not shown). The gas—in particular helium—that is compressed by the compression stage flows in the high pressure pipe or delivery pipe CHP at a pressure P_{HP} of about 15 bar to 20 bar, towards the cold box BF; the mass flow rate through the compressor is written Q_{CMP} and it is assumed to be constant.

Inside the cold box, the flow of heat-conveying gas (helium) is subdivided into two flows: one flow Q_{JT} passes through a Joule-Thomson effect expansion valve V_{JT} (possibly after pre-cooling with liquid nitrogen, not shown), while the remaining flow passes through an expansion turbine TD. Although not shown in the figure, the gas cooled by passing through the turbine TD is injected into counterflow heat exchangers and is used for pre-cooling the flow that passes through the Joule-Thomson valve, upstream from that valve, in application of the principle of the Claude cycle.

A fraction Q^{L}_{JT} of the flow Q_{JT} passing through the Joule-Thomson valve V_{JT} is liquefied as a result of expanding in said valve. The liquid gas as produced in this way is fed to a thermal bath BT, while the fraction Q^{V}_{JT}=Q_{JT} Q^{L}_{JT} remains in the gaseous state. The ratio Q^{V}_{JT}/Q^{L}_{JT} depends in particular on the temperature upstream from the expansion valve.

A consumer CONS, represented by an electrical resistance, is in thermal communication with the bath BT. This consumer dissipates a power Θ (“thermal load”) in the form of heat, thereby causing the liquid gas to evaporate at a rate Q_{W}. This flow rate Q_{W} together with the flow rate Q^{V}_{JT} and the flow rate passing through the expansion turbine are exhausted from the cold box by the low pressure return pipe CBP (P_{BP} of the order of 1.05 bar) to the compressor CMP.

Since said compressor operates at a speed—and thus a volume flow rate—that is constant, the pressure in the pipes CHP and CBP is regulated by a system of controlled valves VC₁, VC₂, and VC₃.

A supply of gas RS at a pressure P_{RS} intermediate between P_{BP} and P_{HP} (e.g. about 9 bar) is connected to the low pressure pipe CBP via a first controlled valve VC₁, and to the high pressure pipe CHP via a second controlled valve VC₂. When the first valve VC₁ is open, gas is injected into the installation from the supply RS at a rate Q_{VC1}: conversely, when the second valve VC₂ is open, gas is evacuated from the installation at a rate Q_{VC2} in order to be stored in the supply RS. The two valves VC₁ and VC₂ must never both be open at the same time.

A third controlled valve VC₃ sets the operating point of the installation by opening or closing a path for bypassing the cold box, with gas flowing therethrough at a rate Q_{VC3}.

In conventional manner (see the above-mentioned article by J. C. Boissin, et al.), the valves VC₁, VC₂, and VC₃ are controlled by two independent regulators, generally of the proportional-integral-derivative (PID) type in order to maintain the pressure values P_{BP} and P_{HP} close to respective setpoint values P⁰_{HP} and P⁰_{HP}.

As shown in FIG. 1A, a first regulator PID1 generates a control signal SC₃ for the valve VC₃ as a function of the difference P_{BP}−P⁰_{BP} in order to regulate the pressure in the return pipe CBP. Similarly, a second regulator PID2 generates a control signal SC₁₂ for the valves VC₁ and VC₂ as a function of the difference P_{HP}−P⁰_{HP} in order to regulate the pressure in the delivery pipe CHP.

The signal SC₁₂ may control the two valves VC₁ and VC₂ in application of a “split range” mechanism SR that operates in the manner shown in FIG. 1B. Assume that the value of the signal SC₁₂ can vary over the range 0 to 1. For SC₁₂=0, the valve VC₁ is fully open, while the valve VC₂ is closed. For 0<SC₁₂<0.5, the opening of the valve VC₁ decreases linearly while the valve VC₂ remains closed. For SC₁₂=0.5, both valves are closed, and for 0.5<SC₁₂≦1, the valve VC₂ opens linearly while the valve VC₁ remains closed. In this manner, it can be ensured that the two valves are never both open at the same time.

The inventors have observed that this regulation strategy is responsible for the dynamic behavior of the installation CRY that is not very satisfactory. The pressure values in the high and low pressure pipes are coupled via the cold box BF, but this coupling is not taken into account by the two independent regulators PID1 and PID2. This gives rise to a “motorboating” effect in the event of the thermal load Θ varying rapidly. If a disturbance changes the value of P_{B}, rapidly, then the first regulator PID1 reacts to oppose that variation; however because of the coupling introduced via the cold box, the action of PID1 inevitably disturbs the value of P_{HP}, thereby triggering intervention of the second regulator PID2. In turn, this intervention disturbs the value of P_{BP} once more, and so on.

This discovery has enabled the inventors to propose a novel control strategy that takes said high pressure/low pressure coupling into account by making use of a multivariable regulator, e.g. of the linear quadratic type, as a replacement for the two independent PID regulators of the prior art.

The so-called “linear quadratic” multivariable control method is well known in the prior art, and reference may be made to the following work:

“Control optimal: théorie et applications” [Optimal control: theory and applications] by Emmanuel Trelat, Editions Vuibert, collections: Mathmatiques concrétes, 2nd edition ISBN: 9782711722198, and in particular Chapter 1; and

“Optimal control: linear quadratic methods” by B. D. O. Anderson and J. B. Moore, Dover Publications, ISBN 9780486457666.

Fundamentally, this is an optimal scheme for controlling a dynamic system defined by a system of linear differential equations, in which the cost function is represented by a quadratic function of the difference between the control variables (P_{HP}, P_{BP}) and their respective setpoints (P⁰_{HP}, P⁰_{BP}), and the magnitudes of the control signals. Under such conditions, optimal control (i.e. control minimizing the cost function) may be obtained by solving an algebraic Riccati equation.

It is difficult to implement multivariable regulation in the cryogenic installation of FIG. 1A because of the split range control SR, which constitutes a constraint that is intrinsically non-linear. The equations that govern the behavior of the installation are not the same while delivering matter (valve VC₁ open) and while removing matter (valve VC₂ open).

In accordance with the invention, this problem is resolved by applying a technique known as “control switching”. In this technique, the system that is to be controlled is modelled by a plurality of independent subsystems, each having its own regulator, with the real system “switching” between them. Specifically, the cryogenic installation SYS may be modelled as two partial models describing the operation of the installation under matter-delivery conditions and under matter-removal conditions, respectively. At each instant, two vector control signals are generated, one for each partial model; a control selector selects which one of these control signals is actually to be applied to the installation.

The partial models are linearized around the operating point of the installation, which cannot be done for an “overall” model that is supposed to take account of the behavior of the systems in both situations at once.

The control switching principle is known, e.g. from the following publications:

D. Liberzon and S. Morse, “Basic problems in stability and design of switched systems”, IEEE Control Systems Magazine, October 1999, pp. 59-70; and

M. Zehran and J. W. Burdick, “Design of switching controllers for system with changing dynamics”, Proceedings of 37^{th} Conference on Decision and Control, 1998.

A regulator implementing the principles of the invention is described in greater detail with reference to FIG. 2.

The pressure values P_{HP} and P_{BP}, as measured in the pipes CHP and CBP respectively, are input to a mathematical model MOD of the installation CRY, which model is made up of two partial models or submodels MP₁, MP₂, representing the behavior of the installation under matter-delivery and matter-removal conditions respectively. These models serve to associate variations over time of the pressures P_{HP} and P_{BP} with “virtual” variations in the opening of the valves CV₁, CV₂. In other words, the partial volumes serve to calculate “virtual openings” O^{V}₁ and O^{V}₂ of said valves that, if they were real, would produce the observed pressure fluctuations (which in reality are generated essentially by variations in thermal load, which variations are not measured directly). It is said that the disturbances to the system are “diverted to the inputs”. It is important to observe that each of the two virtual openings depends both on P_{HP} and on P_{BP}: the models of the system take account of the couplings that exist between the high and low pressure regions of the installation.

A vector is thus made available that is constituted by six input scalar variables that depend on time: the pressures measured in the pipes, P_{HP} and P_{BP}; the respective setpoint values P⁰_{HP} and P⁰_{BP}; and the “virtual openings” O^{V}₁ and O^{V}₂. This vector is delivered as input to a control device DC that is constituted by first and second regulators DC₁ and DC₂. These two mutually-independent regulators are of the linear quadratic type and they are based on the first and second partial models, respectively.

The first regulator DC₁ is for controlling the cryogenic installation CRY under matter-delivery conditions: to do this, it generates control signals (or a first control vector signal) SC₁ and SC′₃ for controlling the valves CV₁ and CV₃ respectively. In contrast, this regulator does not act on the valve CV₂, since under matter-delivery conditions, this valve must remain in the closed state.

In reciprocal manner, the second regulator DC₂ is designed to control the cryogenic installation CRY under matter-removal conditions: to do this, it generates control signals (or a second control vector signal) SC₂ and SC″₃ for controlling the valves CV₂ and CV₃, respectively. However, this regulator does not act on the valve CV₁ since under matter-removal conditions, this valve must remain in the closed state.

It is of interest to observe that the first regulator provides a control signal SC₁ for the valve CV₁ even when the system is under matter-removal conditions; nevertheless, under such circumstances, this control signal corresponds to an opening level for said valve that is not physically achievable, e.g. that is negative. The same applies for the control signal SC₂ generated by the second regulator when the system is in fact under matter-delivery conditions. This enables a control selector SELC to select the control signals SC^{S}₁, SC^{S}₂, SC^{S}₃ that are actually applied to the valves CV₁, CV₂, and CV₃, respectively. For example:

if SC₁<0, then: SC^{S}₁=0; SC^{S}₂=SC₂; and SC^{S}₃=SC″₃ (operating under matter-removal conditions, the regulator DC₂ controlling the system); and

if SC₂<0, then: SC^{S}₁=SC₁; SC^{S}₂=0; and SC^{S}₃=SC′₃ (operating under matter-delivery conditions, the regulator DC₁ controlling the system).

It is also possible to use non-linear regulators DC₁, DC₂ that deliver only opening signals that are physically achievable; under such circumstances, control selection is performed by identifying which one of the signals SC₁ and SC₂ is closer to zero.

There follows an overview of a possible form for the partial models used for implementing the control of the system.

The starting point for obtaining these models is constituted by the equations for conserving mass within the low pressure and high pressure sections (m_{BP}, m_{HP}) of the system SYS:

$$\{ \begin{matrix}\frac{d {m}_{BP}}{d t} = {Q}_{VC 3} + {Q}_{VC 1} - {Q}_{CMP} + {Q}_{W} + {Q}_{JT}^{V} \\ \frac{d {m}_{HP}}{d t} = - {Q}_{VC 3} - {Q}_{VC 2} + {Q}_{CMP} - {Q}_{W} - {Q}_{JT}^{V}\end{matrix}$$

All of the terms on the right-hand side of these equations are described above with reference to FIG. 1A.

However:

Q_{VC3} depends linearly on P_{HP} and non-linearly on the opening level of the valve VC₃, as represented by ouv₃; since the flow of gas in the bypass path is sonic (i.e.

choked), the flow rate does not depend on the downstream pressure P_{BP}. It is thus possible to write:

Q_{VC3}=f₃(P_{HP}, ouv₃)

Q_{VC1} depends linearly on P_{RS} and non-linearly on the opening level of the valve VC₁, represented by ouv₁; since the flow of gas in the bypass path is sonic, the flow rate does not depend on the downstream pressure P_{BP}. Since the pressure in the supply P_{RS} is considered as being constant, it is possible to write:

Q_{VC1}=f₁(ouv₁)

Q_{VC2} depends non-linearly simultaneously on P_{HP}, on the difference P_{H}−P_{AS} (the flow is subsonic since the upstream pressure P_{HP} is less than twice the downstream pressure R_{RS}, and consequently the downstream pressure needs to be taken into consideration), and on the opening level of the valve VC₂, represented by ouv₂. By “hiding” the constant P_{RS} in the non-linear function f₂, it is possible to write:

Q_{VC2}=f₂(P_{HP}, ouv₂)

Q_{W} depends linearly on the heat flow (or thermal load) Θ of the consumer:

Q_{W}=K_{W}·Θ

Q_{CMP} depends linearly on P_{BP}, assuming that the volume flow rate of the compressor is constant and that the density of the gas is proportional to its pressure:

Q_{CMP}=K_{CMP}·P_{BP}

with K_{CMP} constant.

Q_{V}^{JT} depends essentially on the temperature of the gas at the expansion valve V_{JT}; this is a parameter that is independent of the others, and it may be considered as being constant.

The equation of state for the gas (which may be assumed to be perfect) enables the masses m_{BP} and m_{HP} to be associated with the corresponding pressures P_{BP} and P_{HP}.

By replacing these expressions in the mass-conservation equations, a system of two non-linear differential equations is obtained for the pressures P_{BP}, P_{HP}:

$$\{ \begin{matrix}\frac{d {P}_{BP}}{d t} = {F}_{BP} ( {P}_{BP} , {P}_{HP} , {ouv}_{1} , {ouv}_{3} , Θ ) \\ \frac{d {P}_{HP}}{d t} = {F}_{HP} ( {P}_{BP} , {P}_{HP} , {ouv}_{2} , {ouv}_{3} , Θ )\end{matrix}$$

F_{Bp} and F_{HP} are two non-linear functions that may be linearized about two operating points:

a first operating point corresponding to matter-delivery conditions, characterized by ouv₂=0; and

a second operating point corresponding to matter-removal conditions, characterized by ouv₁=0.

Linearizing these equations make it possible to write the two subsystems corresponding to said operating points in the form of state representations in which the pressure values P_{BT}, P_{HP} define the states, with the opening levels of the valves ouv₁, ouv₂, and ouv₃ representing the controls, and with the thermal load Θ constituting an external disturbance.

The linearized equations also make it possible to calculate the “virtual openings” O^{V}₁ and O^{V}₂ as a function of the measured pressures P_{BP}, P_{HP}.

It is thus possible to devise two multivariable regulators for those two subsystems using conventional techniques. It is particularly advantageous to use optimal control of the linear quadratic type.

FIGS. 3A-3C serve to compare the behavior of a system of the invention with a prior art system of the type shown in FIG. 1A. The only difference between the two systems based on the “400 W@1.8K” cryogenic refrigerator-liquefier of the Low Temperature of the Cryogenics and Nanoscience Institute [Institut de Nanosciences et Cryogenie] at Grenoble, France, lies in the regulation strategy that is adopted. The heat-conveying gas is helium, and the thermal bath B is at a temperature of 4.2 K.

Tests have been carried out by sending squarewave pulses having a power of 300 watts (W) for a duration of 50 seconds (s) and at a period of 100 s to a consumer in the form of an electrical resistance. The curves Θ^{INV} and Θ^{REF} in FIG. 3A show the corresponding thermal loads, with variation therein being damped by the thermal inertia of the consumer. The superscript “INV” indicates that the measurements relate to the system of the invention, whereas “REF” relates to reference measurements made on the conventional system.

FIGS. 3B and 3C show variation in the low pressures (P^{INV}_{BP}, p^{REF}_{BP}) and in the high pressures (P^{INV}_{HP}, P^{REF}_{HP}) respectively. It can be seen that the amplitude of the variations in P_{HP} and P_{BT} about their nominal values (P⁰_{BP}=16 bar; P⁰_{BP}=1.05 bar) is reduced by a factor of about three to five when using the control strategy of the invention.

FIGS. 4A to 4C plot curves Θ^{INV} and P^{INV}_{BP}, and P^{INV}_{HP} for a test making use of thermal power delivered as a squarewave at 1000 W. Under such conditions, the prior art systems stop operating (the compressor stops), whereas in the system of the invention, pressure fluctuations remain at levels that are acceptable.

1. A cryogenic system for cooling a consumer presenting a thermal load (Θ) that varies over time, the system comprising:
a cold box in thermal contact with said consumer, fed with a compressed heat-conveying gas by a delivery pipe and connected to a return pipe for exhausting said gas at a lower pressure; and
a unit for regulating the pressures in said delivery and return pipes, the unit comprising a plurality of controlled valves and a control device for controlling the opening of said valves;
the system being characterized in that said control device is a multivariable regulator adapted to generate opening control signals for said valves as a function of measured values and of setpoint values for the pressures of said delivery and return pipes on the basis of a mathematical model of the system, which model takes account of coupling between the pressure values in the delivery and return pipes via said cold box.

2. A system according to claim 1, wherein said control device comprises:
a first regulator for generating a first signal for controlling said valves on the basis of a first partial model of the system;
a second regulator for generating a second signal for controlling said valves on the basis of a second partial model of the system that is different from said first partial model; and
a control selector for selectively applying the first or the second control signal to said valves.

3. A cryogenic system according to claim 1, wherein said regulation unit comprises:
a supply of heat-conveying gas at a pressure that is intermediate between the pressure of said delivery pipe and that of said return pipe;
a first controlled valve arranged between said supply and said return pipe in order to enable gas to be injected into the return pipe from said supply;
a second controlled valve arranged between said supply and said delivery pipe in order to enable gas to be exhausted from the delivery pipe to said supply; and
a third controlled valve arranged between said delivery pipe and said return pipe in order to enable the cold box to be bypassed.

4. A system according to claim 1, wherein said first regulator is adapted to generate a first control signal (SC₁, SC′₃) for opening the first and third valves, to the exclusion of said second valve, on the basis of said first partial model of the system; and said second regulator is adapted to generate a second control signal (SC₂, SC″₃) for opening the second and third valves, to the exclusion of said first valve, on the basis of said second partial model of the system.

5. A system according to claim 2, wherein said first partial model models the behavior of the system when a volume of gas is injected into the return pipe, and said second partial model models the behavior of the system when a volume of gas is extracted from the delivery pipe.

6. A system according to claim 1, wherein said mathematical model of the system models the disturbances in the flow rate of the heat-conveying gas that are induced by variations over time in the heat load of a consumer in thermal communication with said cold box, by means of virtual variations in the openings of the valves of the regulation system, said virtual openings being supplied to said control device as input variables together with the measured and setpoint values for the pressures.

7. A system according to claim 1, wherein said control device is adapted to minimize a cost function that depends on the differences between the pressures measured in the delivery and return pipes and the respective setpoint values therefor, and also on the amplitudes of the control signals generated.

8. A system according to claim 7, wherein said control device is a linear quadratic regulator.

9. A system according to claim 1, wherein the cold box contains a supply of liquefied heat-conveying gas that evaporates in part under the effect of the thermal load of a consumer, the evaporated gas being exhausted via the return pipe and replaced by liquefying at least some of the gas coming from said delivery pipe, the variability over time in the gas evaporation and liquefaction rates, thereby giving rise to disturbances in the pressures within the delivery and return pipes.

10. A system according to claim 1, wherein the consumer is a superconductive magnet that presents a pulsed thermal load.
